(19) United States
(12) Patent Application Publication
(10) Pub. No.: US 2014/0099535 A1
(43) Pub. Date: Apr. 10, 2014

(54) Pouch-Type Battery Cell

(71) Applicant: Seungwoo Chu, Markham (CA)

(72) Inventor: Seungwoo Chu, Markham (CA)

(21) Appl. No.: 14/123,027

(22) PCT Filed: Jun. 1, 2012
(86) PCT No.: PCT/CA2012/000530

§ 371 Date: Nov. 27, 2013

Related U.S. Application Data
(60) Provisional application No. 61/492,071, filed on Jun. 1, 2011.

(51) Int. Cl. H01M 2/08; H01M 2/02

(52) U.S. Cl. CPC H01M 2/08; H01M 2/024
USPC 429/178

(57) ABSTRACT

In an aspect, a battery cell includes a stack that contains at least one anode and at least one cathode, a pouch containing the stack and electrolyte, and anode and cathode terminals. The pouch includes first and second films, each including a metallic main barrier layer and a sealing layer. The main barrier layer substantially prevents passage of oxygen and moisture therethrough. The sealing layer is inboard of the main barrier layer and protects it from exposure to the electrolyte. The pouch includes a flange containing a seal region in which the sealing layers from the first and second films are fixedly joined together to form a common sealing layer to seal the cavity. The thickness of the common sealing layer at a point spaced distally from a proximal end of the seal region is smaller than the thickness of the common sealing layer at the proximal end.

### CROSS REFERENCE TO RELATED APPLICATIONS

This application claims the benefit of U.S. Provisional Application No. 61/492,071, filed Jun. 1, 2011, the contents of which are incorporated herein in their entirety.

### FIELD

The field of this disclosure relates to pouch-type battery cells and more particularly to pouch-type battery cells for battery packs for electric vehicles.

### BACKGROUND

Two types of battery cells that are used in battery packs for electric vehicles or hybrid vehicles include battery cells with rigid housings, and pouch-type battery cells. Pouch-type battery cells offer the potential to provide a greater energy density than those with rigid housings, however, there are several issues with pouch-type batteries. One such problem is their longevity, which can be compromised as a result of several issues as compared to battery cells with rigid housings. While their energy density is good, there is an advantage to being able to increase their energy density.

### SUMMARY

In an aspect, a battery cell is provided, including a stack that contains at least one anode and at least one cathode, a pouch having a cavity containing the stack and electrolyte, an anode terminal and a cathode terminal. The pouch includes a first film and a second film, each of which includes a main barrier layer and a sealing layer. The main barrier layer is metallic and substantially prevents the passage of oxygen (and other gases) and moisture therethrough. The sealing layer is inboard of the main barrier layer and protects the main barrier layer from exposure to the electrolyte. The pouch further includes a flange containing a seal region. In the seal region the sealing layer from the first film is fixedly joined to the sealing layer from the second film so as to form a common sealing layer with the sealing layer from the second film to seal the cavity. The thickness of the common sealing layer at a point spaced distally from a proximal end of the seal region is smaller than the thickness of the common sealing layer at the proximal end of the seal region.

In another aspect, a battery cell is provided, including a stack that contains at least one anode and at least one cathode, a pouch having a cavity containing the stack and electrolyte, an anode terminal and a cathode terminal, wherein the pouch includes a first film and a second film, each of which includes a main barrier layer and a sealing layer. The main barrier layer is metallic and substantially prevents the passage of oxygen and moisture therethrough. The sealing layer is inboard of the main barrier layer and protects the main barrier layer from exposure to the electrolyte. The pouch further includes a flange containing a seal region in which the sealing layer from the first film is fixedly joined to the sealing layer from the second film and forms a common sealing layer with the sealing layer from the second film to seal the cavity. The seal region includes a first sealed subregion in which the common sealing layer is present and a second sealed subregion in which the common sealing layer is present. The second sealed subregion is positioned distally relative to the first sealed subregion. The seal region includes a first unsealed subregion positioned between the first and second sealed subregions. In the first unsealed subregion, the sealing layer from the first film is unjoined to the sealing layer from the second film.

In another aspect, a method is provided of forming a seal region on a battery cell having a stack including at least one anode, at least one cathode and a separator that is electrically insulative between each anode and cathode, the battery cell further including a pouch including a first film and a second film and having a cavity within the pouch between the first and second films, wherein the pouch holds the stack and electrolyte in the cavity, the battery cell further including an anode terminal electrically connected to the at least one anode and extending outwardly from the pouch a cathode terminal electrically connected to the at least one cathode and extending outwardly from the pouch, wherein each of the first and second films includes a main barrier layer and a sealing layer, wherein the main barrier layer is metallic and substantially prevents the passage of oxygen and moisture therethrough, wherein the sealing layer is inboard of the main barrier layer and protects the main barrier layer from exposure to the electrolyte, wherein the pouch further includes a flange containing a seal region, wherein in the seal region the sealing layer from the first film is fixedly joined to the sealing layer from the second film and forms a common sealing layer with the sealing layer from the second film to seal the cavity, the method comprising:

a) applying heat and pressure to a first portion of the flange to join the sealing layer from the first film to the sealing layer from the second film to form a common sealing layer in a first sealed subregion of the seal region having a first thickness;

b) cooling and hardening the common sealing layer in the first subregion; and

c) applying heat and pressure to a second portion of the flange after step b) to join the sealing layer from the first film to the sealing layer from the second film to form a common sealing layer in a second sealed subregion of the seal region having a second thickness that is less than the first thickness.

In another aspect, a method is provided of forming a seal region on a battery cell having a stack including at least one anode, at least one cathode and a separator that is electrically insulative between each anode and cathode, the battery cell further including a pouch including a first film and a second film and having a cavity within the pouch between the first and second films, wherein the pouch holds the stack and electrolyte in the cavity, the battery cell further including an anode terminal electrically connected to the at least one anode and extending outwardly from the pouch a cathode terminal electrically connected to the at least one cathode and extending outwardly from the pouch, wherein each of the first and second films includes a main barrier layer and a sealing layer, wherein the main barrier layer is metallic and substantially prevents the passage of oxygen and moisture therethrough, wherein the sealing layer is inboard of the main barrier layer and protects the main barrier layer from exposure to the electrolyte, wherein the pouch further includes a flange containing a seal region, wherein in the seal region the sealing layer from the first film is fixedly joined to the sealing layer from the second film and forms a common sealing layer with the sealing layer from the second film to seal the cavity, the method comprising:

a) applying heat and pressure to a first portion of the flange to join the sealing layer from the first film to the sealing layer from the second film to form a common sealing layer in a first sealed subregion of the seal region having a first thickness;

b) cooling and hardening the common sealing layer in the first subregion;

c) bending the flange in an unsealed subregion of the seal region after step b); and

d) applying heat and pressure to a second portion of the flange after step c) to join the sealing layer from the first film to the sealing layer from the second film to form a common sealing layer in a second sealed subregion of the seal region. The second sealed subregion may have a second thickness that is less than the first thickness.

### BRIEF DESCRIPTION OF THE DRAWINGS

The foregoing and other aspects will be more readily appreciated having reference to the drawings, wherein:

FIG. 1 is a plan view of an example of a battery cell;

FIG. 2 is a side view of a portion of the battery cell shown in FIG. 1;

FIG. 3 is magnified sectional side view of another portion of the battery cell shown in FIG. 1;

FIGS. 4a and 4b are sectional side views showing different possible placements of a flange on the battery cell shown in FIG. 1;

FIG. 5 is a sectional side view of a configuration for the flange for the battery cell shown in FIG. 1;

FIGS. 6a and 6b are sectional side views illustrating the formation of a seal region on the flange of the battery cell shown in FIG. 1;

FIG. 7 is a sectional side view illustrating another way of forming the seal region on the flange of the battery cell shown in FIG. 1; and

FIG. 8 is a sectional side view of another configuration for the flange for the battery cell shown in FIG. 1.

### DETAILED DESCRIPTION

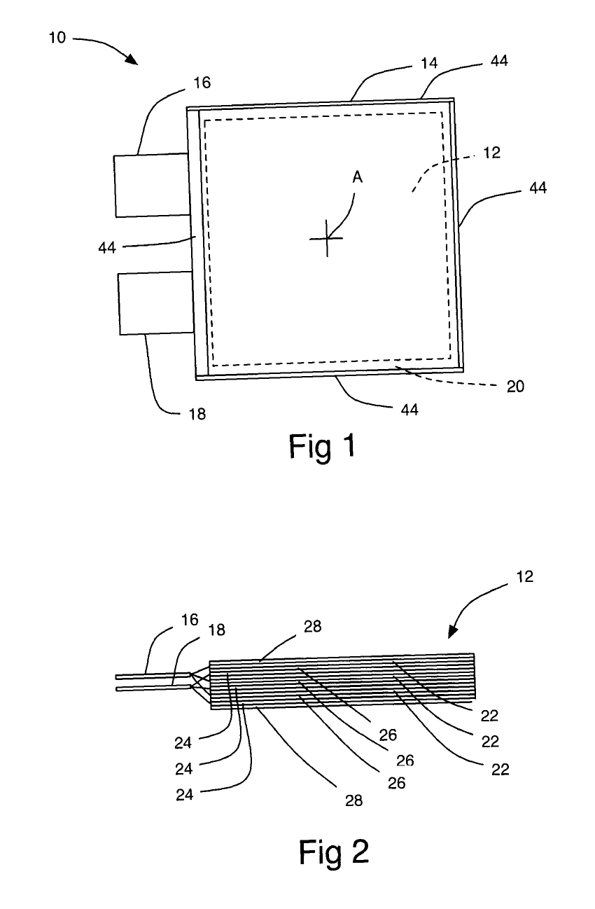

Reference is made to FIG. 1, which shows an example of a battery cell 10. In some embodiments, the battery cell 10 is configured to permit use with a reduced risk of degradation from permeation of oxygen and moisture therein as compared to some battery cells of the prior art. The battery cell 10 includes a stack 12, a pouch 14 having a cavity 15, and anode and cathode terminals 16 and 18. The pouch 14 holds the stack 12 and electrolyte 20 in the cavity 15.

The stack 12, which is shown in more detail in FIG. 2, includes a plurality of anodes 22 alternating with a plurality of cathodes 24. A separator 26 is positioned between each anode 22 and each cathode 24. The separator 26 is electrically insulative between each anode 22 and cathode 24 but permits the passage of Li ions in the electrolyte 20 therethrough, so as to permit Li ion intercalation or de-intercalation to take place between the anode 22 and cathode 24. Alternatively, the stack 12 may have any other suitable arrangement of anodes 22 and cathodes 24 that permits a suitable Li ion intercalation or de-intercalation to occur.

In an example cathode/anode pair 24 based on lithium ion chemistry, the anode sheet 26 may be made from two layers of graphite (such as natural graphite or artificial graphite supplied by Osaka Gas, Japan, or by Timcal, Switzerland) that sandwich a copper foil electrode. Other anode materials may also be employed such as non-graphitizing carbon, metal composite oxides such as LixFe2O3 (0≦x≦1), LixWO2 (0≦x≦1) and SnxMe 1-xMe′ yOz (Me: Mn, Fe, Pb or Ge; Me′: Al, B, P, Si, Group I, Group II, and Group III elements of the Periodic Table of the Elements, or halogens; 0≦x≦1; 1≦y≦3; and 1≦z≦8); lithium metals; lithium alloys; silicon-based alloys; tin-based alloys; metal oxides, such as SnO, SnO2, PbO, PbO2, Pb2O3, Pb3O4, Sb2O3, Sb2O4, Sb2O5, GeO, GeO2, Bi2O3, Bi2O4, and Bi2O5; conductive polymers such as polyacetylene; Li—Co—Ni based materials; LixFe2O3 and LiTiO2; and any combination thereof. The graphite layers may be relatively thin, each having a thickness in the range of about 20-400 μm. The copper foil electrode may also be relatively thin, having a thickness in the range of about 8-50 μm.

The cathode may be made from two layers of lithium metal oxide such as LiCoxMnyNizO2 where x+y+z=1, 0<=x, z<=1, or LiCoO2, LiMn2O4, or LiMnNiAlO2, or LiMePO4, where Me=Fe, Mn, FexMny (x+y=1) and any combination thereof that sandwich an aluminum foil electrode. The lithium metal oxide layers may be relatively thin, each having a thickness in the range of about 30-600 μm. The aluminum foil electrode may be relatively thin, having a thickness in the range of about 10-100 μm.

The separator may be provided by sheets or non-woven fabrics made of an olefin polymer such as polypropylene and/or glass fibers or polyethylene, which have chemical resistance.

The electrolyte 20 may contain carbonates, organic solvent and lithium hexafluoride or some other suitable lithium salt. Other chemistries (e.g. non-Lithium based chemistries) may alternatively be provided however.

While a plurality of anodes 22 and a plurality of cathodes 24 are shown in FIG. 2, it is possible for the stack 12 to include as few as one anode 22, one cathode 24 and one separator 26 therebetween.

Optionally, the stack 12 includes an outer wrap 28, which facilitates handling of the stack 12 prior to insertion into the cavity 15.

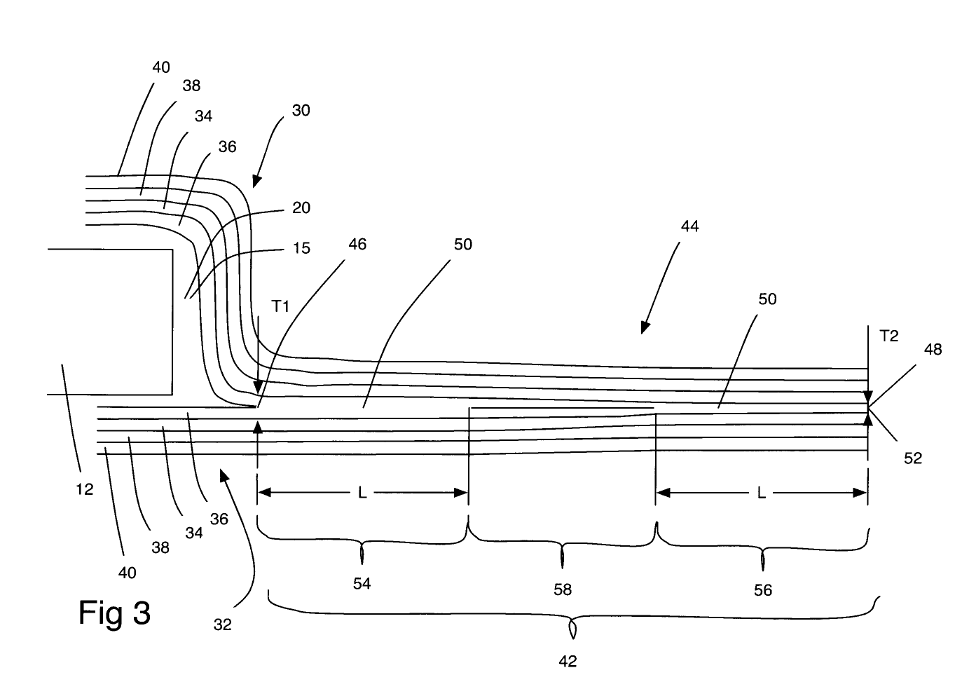

Reference is made to FIG. 3. The pouch 14 includes a first film 30 and a second film 32. For simplicity, the stack 12 is shown in outline only in FIGS. 1 and 3-8. Each film 30, 32 includes a main barrier layer 34 and a sealing layer 36. Each film 30, 32 may optionally include a secondary barrier layer 38. Regardless of whether each film 30, 32 includes a secondary barrier layer 38, each film 30, 32 may optionally include a mechanical protection layer 40.

The main barrier layer 34 substantially prevents the passage of oxygen and moisture therethrough from outside the battery cell 10 into the cavity 15, so as to protect the battery cell 10 from a degradation in performance. The main barrier layer 34 may be made from any suitable material, such as a metallic material. For example, the main barrier layer 34 may be made from aluminum. Alternatively, the main barrier layer 34 may be made from any other suitable metal.

The main barrier layer 34 may have any suitable thickness, such as about 40 microns.

The secondary barrier layer 38 may be positioned outboard of the main barrier layer 34 and provides additional resistance to the passage of oxygen and moisture therethrough from outside the battery cell 10 into the cavity 15. Alternatively the secondary barrier layer 38 may be selected to provide resistance to oxygen or moisture but not both. It is optionally possible to provide a plurality of secondary barrier layers 36 so as to further increase the resistance of the top and bottom films 30, 32 against the passage of oxygen and moisture therethrough into the cavity 15. The secondary barrier layer 38 may be made from any suitable material, such as a polymeric material, such as Nylon™. The secondary barrier layer 38 may have any suitable thickness, such as a thickness of about 20 microns.

The mechanical protection layer 40 provides resistance to a mechanical breach of the main barrier layer 34 (and to a mechanical breach of the secondary barrier layer 38 in embodiments wherein the secondary barrier layer 38 is provided). A mechanical breach of the main barrier layer 34 means the creation of an aperture through the main barrier layer 34 by some mechanical action, such as for example, scratching or puncturing. A mechanical breach 34 would thus expose the stack 12 and electrolyte 20 to oxygen and moisture, and would permit the electrolyte to leak out of the battery cell 10, both of which would degrade the performance of the battery cell 10 and could create a risk of fire or an explosion.

The mechanical protection layer 40 may be made from any suitable material for protecting the main barrier layer 34, such as a suitable polymeric material. For example, the mechanical protection layer 40 may be made from Polyethylene Terephthalate (PET). The mechanical protection layer 40 may have any suitable thickness, such as a thickness of about 20 microns.

It is possible for the secondary barrier layer 38 to provide some mechanical protection of the main barrier layer 34 in addition to providing additional resistance to the flow of oxygen and/or moisture into the cavity 15. Analogously, It is possible for the mechanical protection layer 40 to provide some additional resistance to the flow of oxygen and/or moisture into the cavity 15 in addition to providing mechanical protection of the main barrier layer 34.

The sealing layer 36 is inboard of the main barrier layer 34 and protects the main barrier layer 34 from exposure to the electrolyte 20. The term ‘inboard’ as used herein means ‘on a side that is closer to the cavity 15’. Conversely, the term ‘outboard’ as used herein means ‘on a side that is farther from the cavity 15’. Exposure of the main barrier layer 34 to the electrolyte 20 can result in the exposure of the main barrier layer 34 to HF acid that is in the electrolyte 20. As a result, the main barrier layer 34 dissolves, and additionally, the electrical insulation of the pouch 14 from the stack 12 is broken.

Additionally, the sealing layer 36 permits the first and second films 30 and 32 to be joined to each other to form the pouch 14. The joining of the first and second films 30 and 32 takes place in a seal region 42 that is provided on a peripheral flange 44. The seal region 42 has a first end 46 and a second end 48. The first end 46 is a proximal end that defines an edge of the cavity 15. The second end 48 is a distal end. The term ‘proximal’ and ‘distal’ as used herein refer to relative positioning with respect to the central axis A of the battery cell 10 (shown as a cross hair in FIG. 1). Thus the proximal end 46 is the end that is closer to the axis 15 than the distal end 48 is.

In the seal region 42, the sealing layer 36 from the first film 30 is fixedly joined to the sealing layer 36 from the second film 32 so as to form a common sealing layer 50 with the sealing layer 36 from the second film 32, to seal the cavity 15. The thickness, shown at T1, of the common sealing layer 50 at a point 52 spaced distally from the proximal end 46 is smaller than the thickness, shown at T2, of the common sealing layer 50 at the proximal end 46. Optionally, the point 52 may, as shown in FIG. 3, be at the distal end 48 of the seal region 42. In the embodiment shown, the seal region 42 includes a first sealed subregion 54 in which the common sealing layer 50 is present, a second sealed subregion 56 in which the common sealing layer 50 is present, and a first unsealed subregion 58 positioned between the first and second sealed subregions 54 and 56. In the first unsealed subregion 58 the sealing layer 36 from the first film 30 is unjoined to the sealing layer 36 from the second film 32.

As can be seen in FIG. 3, the distal end 48 of the common sealing layer 50 is exposed to the ambient environment outside the battery cell 10, and, as noted above, is inboard of the main barrier layer 34. As a result, the common sealing layer 50 represents a potential path for migration of oxygen and moisture from outside the battery cell 10 into the cavity 15. In order to inhibit the migration of oxygen and moisture from outside the battery cell 10 into the cavity 15, the material of the sealing layers 36 (and thus for the common sealing layer 50) may be selected to have a low permeability to oxygen and moisture. In an example, the sealing layers 36 and thus the common sealing layer 50 may be made from polypropylene.

The thickness of the common sealing layer 50 may be substantially constant throughout the first sealed subregion 54 and may thus be the same thickness as at the proximal end 46 (i.e. thickness T1). To form the common sealing layer 50 in the first sealed subregion 54, heat and pressure may be applied to the flange 44 in the first sealed subregion 54, so as to at least partially melt the polypropylene in both sealing layers 36 so that the two sealing layers 36 join together. If too much heat and pressure are applied some polypropylene will be squeezed into the cavity 15 forming a bulge. This bulge of heated polypropylene has some level of porosity however. Additionally, some of the heat applied to the first sealed subregion 54 can be absorbed by the electrolyte, thereby causing some of the organic solvent to vaporize in the cavity 15 adjacent the bulge of polypropylene. The vaporized organic solvent can then infiltrate into the porous bulge of polypropylene. After the polypropylene and solvent have cooled, the bulge of polypropylene retains a relatively high porosity. As a result, the electrolyte 20 may at some point migrate through the porous bulge of polypropylene, eventually reaching the material (e.g. aluminum) of the main barrier layer 34, and expose the main barrier layer 34 to the HF acid (or the like) that is in the electrolyte 20, thereby causing the dissolution of the main barrier layer 34 and a breakage in the electrical insulation between the stack 12 and the pouch 14. Ultimately the exposure to the HF acide will result in a breach in the main barrier layer 34. Once the main barrier layer 34 is breached, the secondary barrier layer 38, if provided, is exposed to the electrolyte 20. Depending on the chemistries involved, the secondary barrier 38 may in some cases readily dissolve in the presence of the electrolyte 20. Thus, in a relatively short period of time, the secondary barrier layer 38 may be breached by the electrolyte 20. Similarly, the mechanical protection layer 40 may readily dissolve into solution in the organic solvent at which point the contents of the cavity 15 would be exposed to the ambient environment outside the battery cell 10. Alternatively, even if one or both of the secondary barrier layer 38 and the mechanical protection layer 40 are not breached by the electrolyte 20, these layers 38 and 40 may have much higher permeability to oxygen and/or moisture compared with the main barrier layer 34 and may thus permit a quickened degradation of the performance of the battery cell 10 from the infiltration into the cavity 15 by oxygen and moisture.

Thus, the thickness of the first sealed subregion 54 may be selected so that the heat and pressure needed to achieve that thickness results in less than a selected amount of flow of the material of the sealing layers 36 into the cavity 15 to form a bulge. In an example, suitable results can be obtained when the thickness of the sealing layer 36 on the first and second films 30 and 32 is about 80 microns, and the resulting thickness of the common sealing layer 50 in the first sealed subregion 54 is 120 microns. Thus, in this example, the thickness of the common sealing layer 50 in the first sealed subregion 54 is about 75% of the initial thickness prior to the application of heat and pressure. The initial thickness would be about 160 microns, the sum of the thicknesses of the two sealing layers 36. A thickness for the common sealing layer 50 that is greater than about 75% (i.e. between about 75% and about 100%) of the sum of the thicknesses of the two sealing layers 36 would also provide less than the selected amount of flow of the material of the sealing layers 36 into the cavity 15 to form a bulge.

It will be noted that having a larger thickness results in a greater permeability of the common sealing layer 50 in the first sealed subregion 54 to the passage of oxygen and moisture therethrough into the cavity 15, however. To address this, the thickness of the common sealing layer 50 in the second sealed subregion 56 may be less than the thickness of the common sealing layer 50 of the first sealed subregion. Less regard may be needed for precisely limiting the heat and pressure used to compress and join the sealing layers 36 in the second sealed subregion 56 than may be used when forming the first sealed subregion 54 because the material of the sealing layers 36, even if rendered relatively more porous, is blocked from exposure to the electrolyte 20 by the first sealed subregion 54. Thus, the heat and pressure used to join the sealing layers 36 in the second sealed subregion 56 can be selected so as to provide a relatively high degree of compression in the common sealing layer 50 relative to the initial thickness of the two sealing layers 36. In an example, the thickness of the common sealing layer 50 in the second sealed subregion 56 may be about 50% of the initial thickness of the sealing layers 36. Thus, the thickness of the common sealing layer 50 in the second sealed subregion 56 may be about 66% of the thickness of the common sealing layer 50 in the first sealed subregion 54. In general, the permeability of the common sealing layer 50 is proportional to the thickness of the common sealing layer 50, and is inversely proportional to the length of the common sealing layer 50.

It can thus be seen that the permeability of the seal region 42 having both the first and second sealed subregions 54 and 56 will thus be less than the permeability of the seal region 42 if it were only to include the first sealed subregion 54. In the aforementioned example, if the thickness T2=0.66×T1, the impact of the change in thickness alone on the permeability of the common sealing layer 50 in the seal region 42 (i.e. in the first and second subregions 54 and 56) may be that the permeability drops to about 75% of the permeability associated with the first sealed subregion 54 alone. If the lengths of the common sealing layer 50 in each of the first and second sealed subregions 54 and 56 is the same value, L, then the impact of the increased path length on the permeability of the seal region 42 is to cut the permeability in half. Thus in the embodiment shown in FIG. 3 the permeability of the seal region 42 having subregions 54 and 56 is would be 75%×50%=37.5% of the permeability of the seal region 42 if it only included the first sealed subregion 54. This reduction in permeability, achieved without an increased risk of creating a porous bulge of sealing layer material in the cavity 15 can result in the battery cell 10 having an operating life that is longer than that of some proposed or available battery cells. The increased operating life may render the battery cell 10 well suited for vehicular use (e.g. in a battery electric vehicle, or in a hybrid vehicle).

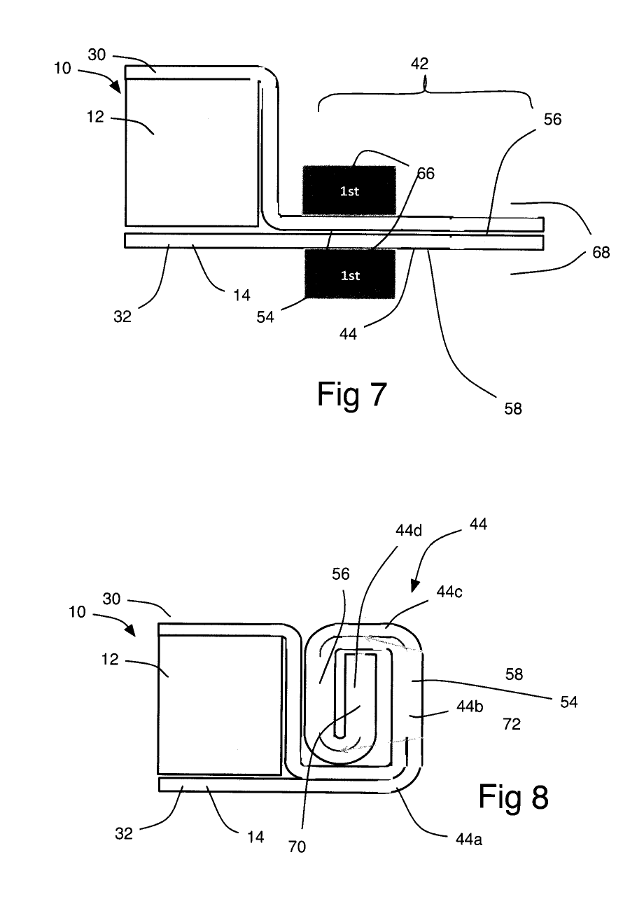

Also, by virtue of having the second sealed subregion 56 that provides a relatively low level of permeability to the seal region 42 to the passage of oxygen and moisture, the thickness of the common sealing layer 50 in the first sealed subregion 54 may be selected to be sufficiently large to ensure that substantially all of the pouches 14 that are formed during the production process are usable even if the sealing layers 36 on the first and second films 30 and 32 are at a high end of their tolerance range (and would thus incur a relatively higher amount of compression than is expected) and even if the temperatures of the heat sealing plates (shown at 66 in FIGS. 6a, 6b and 7) are at a high end of their tolerance range. In other words, the production process may be set up so that there is a sufficiently small amount of compression that occurs in the first sealed subregion so as to ensure that few, if any, of the resulting pouches 14 have porous bulges in the cavity 15 that will be exposed to electrolyte 20 even if the components involved in the process are at the ends of their tolerances ranges, without causing a high permeability in the resulting pouches 14. This may result in reduced scrap during production and/or a reduced percentage of premature failure of the battery cells 10 in the field.

While FIG. 3 shows a first unsealed subregion 58 between the first and second sealed subregions 54 and 56, it is possible in some embodiments for the first and second sealed subregions 54 and 56 to be substantially immediately adjacent each other. This may still result in less than a selected flow of heated, porous sealing layer material into the cavity 15, since the sealing layer material may preferentially flow outwardly, away from the cavity, due, for example, to a lower resistance to such flow than to a flow inwardly towards the cavity 15. This may be particularly true if the common sealing layer 50 in the immediately adjacent first sealed subregion 54 has cooled and hardened.

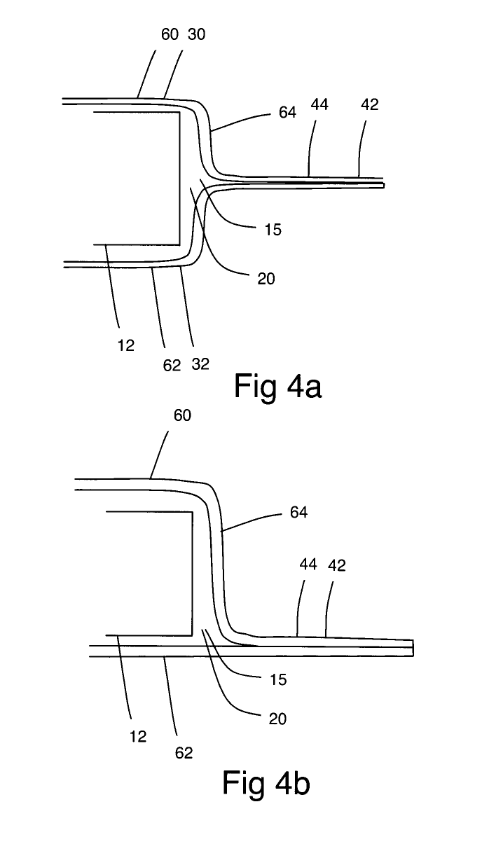

Reference is made to FIGS. 4a and 4b. The battery cell 10 has a first side face 60, a second side face 62 and a peripheral edge face 64. As shown in FIG. 4a, it is possible for the flange 44 to be positioned substantially in the middle of the edge face 64. As shown in FIG. 4b, it is alternatively possible for the flange 44 to be positioned proximate to one of the first or second side faces 60 or 62. For simplicity, the first and second films 30 and 32 are shown as single layers in FIGS. 1-2 and 4a-8.

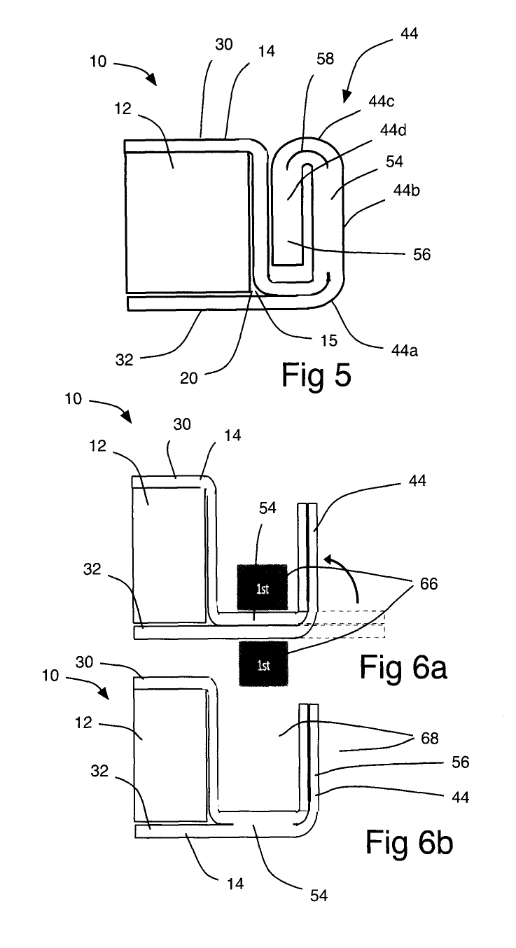

Reference is made to FIG. 5. After forming the seal region 42 with the first and second subregions 54 and 56 with the first unsealed subregion 58 between them, the flange 44 may be folded so as to reduce the occupied volume of the battery cell 10, thereby increasing its energy density, and permitting a greater number of such battery cells 10 to fit in a battery pack (not shown) having a selected volume. In embodiments wherein the flange 44 is folded subsequent to formation of the seal region 42, the flange 44 may be positioned proximate one of the first and second side faces 60 or 62 (in this example the flange 44 is shown as being positioned proximate to the second side face 62).

As can be seen in FIG. 5, the flange 44 is folded so as to have a first fold 44a, a first generally linear section 44b, a second fold 44c and a second generally linear section 44d, wherein the first and second generally linear sections 44b and 44d are folded with respect to each other and with respect to the edge face 64, via the first and second folds 44a and 44c, and contain the first and second sealed subregions 54 and 56 respectively. As can also be seen in FIG. 5, the first and second folds 44a and 44c are contained within portions of the flange 44 in which the sealing layer 36 from the first film 30 is unjoined with the sealing layer 36 from the second film 32 (such as in unsealed subregion 58 and in a portion of the flange 44 that is proximal relative to the seal region 42).

In embodiments wherein the flange 44 will be folded, such as that which is shown in FIG. 5, the seal region 42 may be formed in such a way as to reduce mechanical stresses that might occur as a result of the differential path length that would occur when the portions of the first and second films 30 and 32 that make up the flange 44 are folded. The differential path length occurs as the result of the different bending radius that each of the films 30, 32 undergoes relative to the other when the flange 44 is folded. FIGS. 6a and 6b illustrate a process of forming the seal region 42 in such a way as to reduce mechanical stresses. For example, a first pair of heat sealing plates 66 may be applied to the flange 44 as shown in FIG. 6a so as to form the first sealed subregion 54. At some point, either before the first pair of heat sealing plates 66 are applied, during the period in which the heat sealing plates 66 are applied, or after the heat sealing plates 66 are applied, the flange 44 is folded in a region that is spaced from the location of the heat sealing plates 66. After the flange 44 has been folded a second pair of heat sealing plates 68 (FIG. 6b) is applied to the flange 44 to form the second sealed subregion 56. It will be noted that the flange 44 has only been folded by about 90 degrees prior to the application of the second pair of heat sealing plates 68, even though in the final product the flange 44 will be folded through about 180 degrees. This is to provide access by both heat sealing plates 68 to both sides of the flange 44.

As shown in FIG. 7, the first and second pairs of heat sealing plates 66 and 68 may be applied to the flange 44 before the flange 44 is folded, in at least some embodiments.

Referring to FIG. 8, the seal region 42 may further include a third sealed subregion 70 that is positioned distally relative to the second sealed subregion 56, and may further include a second unsealed subregion 72 positioned between the second and third sealed subregions 56 and 70. The thickness of the common sealing layer 50 in the third sealed subregion 70 may be the same as or different than the thickness of either of the common sealing layer 50 in the first or second sealed subregions 54 and 56.

As can be seen in FIG. 8, the flange 44 is folded so as to have a first fold 44a, a first generally linear section 44b, a second fold 44c, a second generally linear section 44d, a third fold 44e, and a third generally linear section 44f, wherein the first, second and third generally linear sections 44b, 44d and 44f are folded with respect to each other and with respect to the edge face 64, via the first, second and third folds 44a, 44c and 44e, and contain the first, second and third sealed subregions 54, 56 and 70 respectively. As can also be seen in FIG. 8, the first, second and third folds 44a, 44c and 44e are contained within portions of the flange 44 in which the sealing layer 36 from the first film 30 is unjoined with the sealing layer 36 from the second film 32 (such as in unsealed subregions 58 and 72 and in a portion of the flange 44 that is proximal relative to the seal region 42). Folding the flange 44 as shown in FIG. 5 or 8 may reduce the exposure of the distal end 48 of the seal region 42 to oxygen and moisture in particular as compared to some embodiments wherein the flange 44 is not folded.

It will be noted that the flange 44 is not necessarily folded proximate the edge face 64 throughout the entire perimeter of the pouch 14. As can be seen in FIG. 1, for example, on the side edge of the battery cell 10 from which the anode and cathode terminals 16 and 18 extend, the flange 44 may remain unfolded, even though it is folded on the other three side edges of the battery cell 10.

Referring to FIGS. 1 and 2, the anode terminal 16 is electrically connected to the plurality of anodes 22 and extends outwardly from the pouch 14. Similarly, the cathode terminal 18 is electrically connected to the plurality of cathodes 24 and extends outwardly from the pouch 14. In the embodiment shown, the anode and cathode terminals 16 and 18 are connected in parallel to the anodes 22 and cathodes 24 respectively, however other arrangements (e.g. series arrangements) may be provided. The anode and cathode terminals 16 and 18 are shown as being vertically offset in FIG. 2, however this is for illustration only. In the battery cell 10 the terminals 16 and 18 are co-planar.

It will be noted that, particularly in embodiments wherein the flange 44 is folded, it may be advantageous to provide the seal region 42 with a plurality of sealed subregions (e.g. the first sealed subregion 54 and the second sealed subregion 56) with an unsealed subregion (e.g. first unsealed subregion 58) between each adjacent pair of sealed subregions. This permits the flange 44 to be folded in the unsealed subregions while reducing mechanical stress of the common sealing layer 50. In particular, it has been found that, in some instances, the formation of a common sealing layer in a battery cell pouch introduces thermal stresses into the material (e.g. the polypropylene). When a mechanical stress is also introduced into the common sealing layer, such as would occur if the common sealing layer 50 were folded, microcracks in the common sealing layer can result. During use, the battery cell will undergo expansion and contraction which can propagate and enlarge the microcracks, ultimately increasing the permeability of the common sealing layer and hastening the degradation of the performance of the battery cell. By contrast, in embodiments wherein the flange 44 is folded in an unsealed subregion such mechanical stresses may be reduced in the common sealing layer 50 thereby reducing the generation and propagation of microcracks. Furthermore, by providing a plurality of sealed subregions separated by unsealed regions, if a microcrack was generated and made its way along the entirety of sealed subregion 54 for example, the unsealed subregion that separates sealed subregion 54 from sealed subregion 56 may act as a crack arrestor so that the crack does not simply propagate quickly throughout the entirety of the seal region 42.

Those skilled in the art may make other modifications and variations to the embodiments described herein without departing from the scope as defined by the following claims.

1. A battery cell, comprising:
a stack including at least one anode, at least one cathode and a separator that is electrically insulative between each anode and cathode;
a pouch including a first film and a second film and having a cavity within the pouch between the first and second films, wherein the pouch holds the stack and electrolyte in the cavity;
an anode terminal electrically connected to the at least one anode and extending outwardly from the pouch; and
a cathode terminal electrically connected to the at least one cathode and extending outwardly from the pouch,
wherein each of the first and second films includes a main barrier layer and a sealing layer,
wherein the main barrier layer is metallic and substantially prevents the passage of oxygen and moisture therethrough, wherein the sealing layer is inboard of the main barrier layer and protects the main barrier layer from exposure to the electrolyte, wherein the pouch further includes a flange containing a seal region, wherein in the seal region the sealing layer from the first film is fixedly joined to the sealing layer from the second film so as to form a common sealing layer to seal the cavity, wherein the thickness of the common sealing layer at a point spaced distally from a proximal end of the seal region is smaller than the thickness of the common sealing layer at the proximal end of the seal region.

2. A battery cell as claimed in claim 1, wherein each of the first and second films further includes a secondary barrier layer that is outboard of the main barrier layer and that substantially prevents the passage of at least one of oxygen and moisture therethrough.

3. A battery cell as claimed in claim 1, wherein each of the first and second films further includes a mechanical protection layer that is outboard of the main barrier layer and that protects the main barrier layer from scratching.

4. A battery cell as claimed in claim 1, wherein the main barrier layer is made from aluminum.

5. A battery cell as claimed in claim 1, wherein the electrolyte contains a Lithium salt.

6. A battery cell as claimed in claim 1, wherein the sealing layer is polypropylene.

7. A battery cell as claimed in claim 1, wherein the seal region includes a first sealed subregion in which the common sealing layer has a first thickness and a second sealed subregion positioned distally relative to the first sealed subregion, wherein in the second sealed subregion the common sealing layer has a second thickness that is smaller than the first thickness.

8. A battery cell as claimed in claim 7, wherein the seal region includes a first unsealed subregion positioned between the first and second sealed subregions, wherein in the first unsealed subregion, the sealing layer from the first film is unjoined to the sealing layer from the second film.

9. A battery cell as claimed in claim 8, wherein the battery cell has a first side face, a second side face and an edge face, the flange is folded so as to have a first fold, a first generally linear section, a second fold and a second generally linear section, wherein the first and second generally linear sections are folded with respect to each other and with respect to the edge face via the first and second folds, and contain the first and second sealed subregions respectively and wherein the first and second folds are contained within portions of the flange in which the sealing layer from the first film is unjoined with the sealing layer from the second film.

10. A battery cell as claimed in claim 1, wherein the battery cell has a first side face, a second side face and a peripheral edge face between the first and second side faces, wherein the flange is positioned proximate to one of the first and second side faces.

11. A battery cell as claimed in claim 9, wherein the seal region includes a third sealed subregion and a second unsealed subregion between the second and third sealed subregions.

12. A battery cell as claimed in claim 11, wherein the battery cell has a first side face, a second side face and an edge face, and wherein the flange is folded so as to have a first fold, a first generally linear section, a second fold, a second generally linear section, a third fold, and a third generally linear section, wherein the first, second and third generally linear sections are folded with respect to each other and with respect to the edge face via the first, second and third folds, and contain the first, second and third sealed subregions respectively, and wherein the first, second and third folds are contained within portions of the flange in which the first sealing layer is unjoined with the second sealing layer.

13. A battery cell as claimed in claim 1, and wherein the thickness of the common sealing layer at a distal end of the seal region is smaller than the thickness of the common sealing layer at a proximal end of the seal region.

14. A battery cell, comprising: a stack including at least one anode, at least one cathode and a separator that is electrically insulative between each anode and cathode; a pouch including a first film and a second film and having a cavity within the pouch between the first and second films, wherein the pouch holds the stack and electrolyte in the cavity an anode terminal electrically connected to the at least one anode and extending outwardly from the pouch; and a cathode terminal electrically connected to the at least one cathode and extending outwardly from the pouch, wherein each of the first and second films includes a main barrier layer and a sealing layer, wherein the main barrier layer is metallic and substantially prevents the passage of oxygen and moisture therethrough, wherein the sealing layer is inboard of the main barrier layer and protects the main barrier layer from exposure to the electrolyte, wherein the pouch further includes a flange containing a seal region, wherein in the seal region the sealing layer from the first film is fixedly joined to the sealing layer from the second film and forms a common sealing layer with the sealing layer from the second film to seal the cavity, wherein the seal region includes a first sealed subregion in which the common sealing layer is present and a second sealed subregion in which the common sealing layer is present, wherein the second sealed subregion is positioned distally relative to the first sealed subregion, wherein the seal region includes a first unsealed subregion positioned between the first and second sealed subregions, wherein in the first unsealed subregion, the sealing layer from the first film is unjoined to the sealing layer from the second film.

15. A battery cell as claimed in claim 14, wherein the battery cell has a first side face, a second side face and an edge face, the flange is folded so as to have a first fold, a first generally linear section, a second fold and a second generally linear section, wherein the first and second generally linear sections are folded with respect to each other and with respect to the edge face via the first and second folds, and contain the first and second sealed subregions respectively and wherein the first and second folds are contained within portions of the flange in which the first sealing layer is unjoined with the second sealing layer.

16. A battery cell as claimed in claim 15, wherein the seal region includes a third sealed subregion and a second unsealed subregion between the second and third sealed subregions.

17. A battery cell as claimed in claim 16, wherein the battery cell has a first side face, a second side face and an edge face, and wherein the flange is folded so as to have a first fold, a first generally linear section, a second fold, a second generally linear section, a third fold, and a third generally linear section, wherein the first, second and third generally linear sections are folded with respect to each other and with respect to the edge face via the first, second and third folds, and contain the first, second and third sealed subregions respectively, and wherein the first, second and third folds are contained within portions of the flange in which the first sealing layer is unjoined with the second sealing layer.
